(19) United States
(12) Patent Application Publication
(10) Pub. No.: US 2014/0357346 A1
(43) Pub. Date: Dec. 4, 2014

(54) SYSTEM AND METHOD FOR PLACING BETS AND/OR LOTTERY WAGERS

(71) Applicant: Laverock Von Schoultz Limited, London (GB)

(72) Inventors: Simon ORDISH, London (GB); Stuart Freeman, Haslemere (GB); Martin Velicky, London (GB); Pascal Blyau, Biarritz (FR)

(21) Appl. No.: 14/292,638

(22) Filed: May 30, 2014

(30) Foreign Application Priority Data
May 31, 2013 (EP) EP13305726.5

(51) Int. Cl. G07F 17/32

(52) U.S. Cl. CPC G07F 17/3241; G07F 17/3244
USPC 463/25

(57) ABSTRACT

A gaming system for placing bet and/or lottery wager orders includes at least one portable player identification device (12), each player identification device (12) storing a respective digital invariant unique identification code in a memory (14) and including a short range wireless communication interface (16) enabling to read the identification code in the memory; and at least one interface (8, 10) having a short range wireless communication reader (24, 30) for reading the identification code stored in a player identification presented to the reader (24, 30), the interface being configured to confirm execution of a pending bet and/or lottery wager order to a gaming platform (3), each pending order being associated to an identification code, with requesting presentation of the player identification device (12) matching the identification code associated to the pending order to allow confirmation of the pending order.

This claims the benefit of European Patent Application EP 13305726.5, filed May 31, 2014 and hereby incorporated by reference herein.

The present invention relates to methods and systems for booking and placing bets and lottery wagers.

### BACKGROUND

A strong expectation within the betting and lottery industry is to optimize the process of selling bets and lottery wagers to players in retail shops, while reducing the costs and efforts in relation to such sales, producing easy intuitive access to massive up to date accurate information required for betting and easy way of recognizing players usually seen as completely anonymous.

In many countries, private or public operators operate betting and/or lottery licenses according to which they sell bets and/or lottery wagers to players through various channels such as retail shops, Internet websites, automated teller machines, etc.

Betting operators are offering various options to players to bet on future events. Such events are often but not only related to sport, such as a match, a tournament, a race, etc. . . . For each possible outcome, the betting operators propose or agree on a price used to calculate how many times the stake of the player will be paid when his prediction is correct. Betting operators are usually offering players the possibility to bet on one or several options that can be arranged or combined in multiple ways. Betting operators can also offer additional betting games such as but not limited to pari-mutual and pooled betting games, which are based on one event or a list of events such as but not limited to a list of football matches for which the players have to predict the result of each match, horse races for which the players have to predict the first horses and their order at arrival, etc . . . and for which the players predicting the correct result get a portion of the global stakes of the other players.

Lottery operators offer various games of chance such as pooled or fixed odds games, where for instance players try to predict which numbers among possible numbers will be drawn by a draw method based on chance and where players predicting the correct result get a portion of the global stakes of the other players or a fixed prize.

It is possible for betting operators and/or lottery operators to offer their products through a network of retailers. Each retailer is provided for example with a retail terminal The retailer may manually enter selections of the players in the retail terminal, or the retail terminal may be equipped with an optical reading device capable of reading selections of the players written on paper coupons. The retail terminal is connected through a data communication network to a gaming system for processing bets and/or lottery wagers. The retail terminal is used to send orders containing the betting information or the lottery wager information, including the player's selection and the stake.

A retail terminal is also configured to print a paper receipt containing the player selection and a unique transaction number associated to the transaction. The transaction number may be coded, for example in a bar code or a QR code.

The gaming system gets all the results related to the events and calculates the amount to pay for each winning receipt according to the detailed rules of the betting and/or lottery games.

Players use their receipts to claim the payment of their winning Retail terminals are used to read the receipts and to send a payment request to the gaming system to return the amount to be paid to the players and to record such payment transaction was done.

Players need to get access to massive information to prepare bet selections. Many of betting operators distribute large lists of betting options to be made available to the players at the retailers' facilities. However, such information becomes very quickly inaccurate as, very often, betting options can be modified and as the prices can change from time to time.

There is a need to secure and ease bets and/or lottery placement operations for players, retailers and operators.

### SUMMARY OF THE INVENTION

It is an object of the present invention to provide a bets and/or lottery system that secures and eases bets and/or lottery wager placement for players, retailers and operators.

The present invention provides a gaming system for placing bet and/or lottery wager orders, the gaming system comprising:

at least one portable player identification device, each player identification device storing a respective digital invariant unique identification code in a memory and comprising a short range wireless communication interface enabling to read the identification code in the memory;

at least one interface having a short range wireless communication reader for reading the identification code stored in a player identification presented to the reader, the interface being configured to confirm execution of a pending bet and/or lottery wager order to a gaming platform, each pending order being associated to an identification code, with requesting presentation of the player identification device matching the identification code associated to the pending order to allow confirmation of the pending order.

In specific embodiments, the gaming system may comprise one or several of the following features, taken in isolation or in any technically feasible combination:

the gaming system comprises a player interface freely accessible to at least one player;

the player interface is configured for preparation of bet and/or lottery wager orders;

the player interface is configured to associate an identification code to a prepared order by reading the identification code stored in a portable player identification device via short range communication;

the player interface is configured for confirming a pending order to the gaming platform with requesting presentation of the player identification device matching the identification code associated to the pending order to allow confirmation of the pending order;

the gaming system comprises a retailer interface accessible to a retailer;

the retailer interface is configured to retrieve pending offers from the gaming platform;

the retailer interface is configured for preparation of bet and/or lottery wager orders;

the retailer interface is configured to associate an identification code to a prepared order by reading the identification code stored in a portable player identification device via short range communication;

the retailer interface is configured for confirming a pending order to the gaming platform with requesting presentation of the player identification device matching the identification code associated to a pending order to allow confirmation of the pending order;

the gaming system comprises a gaming platform configured for recording pending bet and/or lottery wager orders prepared by players and for executing pending order upon confirmation, each pending order being associated to an identification code;

each interface is in communication with the gaming platform over a data communication network.

The invention also relates to a method of ordering bets and/lottery wagers, comprising preparing and storing at least one pending bet and/or lottery wager order, each pending order being associated to an identification code, and confirming each pending order for execution of the order in a gaming platform only upon reading via short range communication an identification code stored in a portable player identification device storing a digital invariant unique identification code, the identification code read matching the identification code of the pending order.

In a particular embodiment, the method comprises associating an identification code to a prepared order by reading via short range communication the identification code stored in a portable player identification device.

### BRIEF DESCRIPTION OF THE DRAWINGS

The invention and its advantages will be better understood on reading the following description, given solely by way of non limiting example, and made with reference to the appended drawings, in which:

FIG. 1 is a diagram representing a gaming system for ordering bets and/or lottery wagers; and

FIG. 2 is a flowchart representing a process of ordering bets and/or lottery wagers using the gaming system.

### DETAILED DESCRIPTION

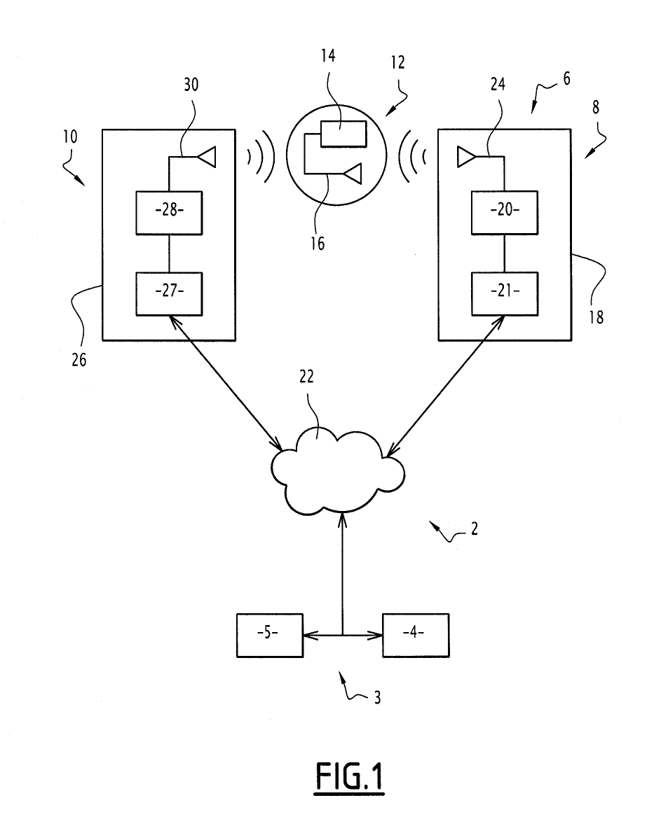

The gaming system 2 illustrated on FIG. 1 allows a player to prepare or book bet and/or lottery wager orders and to subsequently place the orders. In the present application, “prepare an order” refers to the player preparing selection and predictions in relation to events optionally with associated stake(s) and “place an order” or “execute the order” refers to execution of the order, that is triggering the bet or lottery wager placement after payment.

The gaming system 2 comprises a computer gaming platform 3 and an ordering system 6.

The gaming platform 3 is configured for managing booking of bet and/or lottery wager orders, executing bet and/or lottery wagers placed by players in relation to result of future events, for receiving the results of the events, and for calculating gains associated to each winning bet or lottery wager.

A bet or a lottery wager contains predictions of a player. A bet may relate to sport events such as sport races, car races, horse races, sport matches . . . A lottery wager corresponds to predictions relating to random event, such as a lottery implemented for example by a lottery server.

As illustrated in FIG. 1, the gaming platform 3 comprises a booking server 4 for managing pending bet and/or lottery orders and a gaming server 5 for executing bet and/or lottery wager orders placed by players in relation to result of future events, for receiving the results of the events, and for calculating gains associated to each winning bet or lottery wager.

As illustrated in FIG. 1, the ordering system 6 comprises a player interface 8, a retailer interface 10 and a player identification device 12.

The player identification device 12 is a portable electronic device to be carried by a player. The player identification device 12 comprises a memory 14 having stored therein an invariant unique identification code for identifying a player.

The player identification device 12 comprises a communication interface 16 configured for exchanging data using short range wireless communication technology, preferably radiofrequency short range wireless communication technology. Examples of short range wireless communication technology are NFC (Near Field Communication) or WIFI using radiofrequency communication, or Bluetooth or Radio-frequency Identification (RFID). The communication interface 16 comprises for example a radiofrequency antenna.

In one embodiment, the player identification device 12 comprises a dedicated physical support such as a token or a card supporting the memory 14 and the communication interface 16.

In an alternative embodiment, the player identification device 12 comprises a mobile device natively incorporating the communication interface 16. The player identification device 12 comprises for example a mobile device such as a smartphone or an electronic tablet natively incorporating the communication interface 16.

The player interface 8 is configured for enabling a player to prepare bet and/or lottery wager orders. Optionally, the player interface 8 is configured to receive information relating to results of events and potential wins corresponding to bet and/or lottery wager orders placed by the player in relation to the events.

The player interface 8 comprises an electronic player device 18 owned by the player or installed at a retailer and a player application 20.

The player device 18 is connected to the gaming platform 3 through a data communication network 22. The data communication network 22 is for example Internet, a LAN, a WLAN, a satellite communication network . . .

The player device 18 comprises in a known manner a processor, a memory, a display. The player device 18 comprises a network interface 21 for communication through the communication network 22.

The player application 20 is a software application installed on the player device 18. Alternatively, the player application 20 is hosted on a remote server, namely the booking server 4, the player device 18 enabling the player to access the player application 20 through the communication network 22.

The player interface 8 comprises a player interface reader 24 adapted to communicate with the player identification device 12 via short range wireless communication.

The player interface reader 24 is configured for reading the identification code stored in the player identification device 12 upon presentation of the player identification device 12 to the player interface reader 24. Reading is possible only if the player identification device 12 is close enough from the player interface reader 24.

The player interface 8 is configured for displaying to the player bet and/or lottery offers and related information received from the gaming platform 3, namely the booking server 4. Offers comprise bet on events or participation to lottery. Related information comprises for example the odd. The offers and the related information are displayed on the player device 8 by the player application 20. They are updated regularly, preferably on a real-time basis, to deliver precise information to the player willing to place bets.

The player interface 8 is configured to allow a player to prepare bet and/or lottery wager orders. An order contains predictions of the player relating to bets and/or lotteries. An order may also contain stakes that the player wished to associate to each bet or lottery.

The player interface 8 is configured to communicate to the gaming platform 3 each order prepared by a player.

The player may have a personal account hosted in the gaming platform 3. The player interface 8 is configured to allow the player to access his account. The account may contain tailored offers, tailored information, personal promotions in relation to a loyalty program, player's attribute . . .

The player identification device 12 and the player interface reader 24 allow identifying the player currently using the player interface 8. The player interface 8 is preferably configured to open a player account matching an identification code upon presenting the player identification device 12 containing the said identification code to the player interface reader 24.

The player interface 8 is configured to allow a player to prepare and store a bet and/or lottery order prepared on the player identification device 12.

Preferably, the player interface 8 is configured to associate an identification code to a prepared order by reading the identification code in a player identification device 12 presented to the player interface reader 24. The player interface 8 is configured to communicating the pending order and the associated identification code to the gaming plateform 3.

In one embodiment, the player interface 8 is further configured to allow a player to confirm execution of a bet and/or lottery order. The player interface 8 is configured such that confirmation of a pending order requires presenting the player identification device 12 having the identification code matching that of the pending order before the player interface reader 24. The player interface 8 is configured to confirm execution of a pending order to the gaming platform 3 upon presentation of the player identification device 12 having the identification code matching that of the pending order before the player interface reader 24.

In a possible sequence, the player interface 8 may request a player sequentially to select an order, to confirm that the player wants to execute the order by activating a physical or tactile button and to present the player identification device 12 to the player device reader 18 for finalizing the transaction.

In such an embodiment, the player interface 8 is configured to operate the transaction, that is to ensure that the players pays for the order he places before communicating the placement of the order to the gaming platform 3.

In one embodiment, the player may prepay an amount of money, which is associated to the identification code of the player in the gaming platform 3. The remaining amount of money is updated depending on the prices of the orders placed, on the new deposits of the player and optionally on the wins of the player (where authorized). The player interface 8 is configured to check that the remaining money matches the price of the order the payer wants to place.

Alternatively or optionally, the player interface 8 comprises transaction means allowing the player to pay using payment means such as a credit card. Payment means may comprise a credit card reader or a banknote reader. A credit card natively incorporating short range communication technology may be read using the payer device reader 20.

The retailer interface 10 is configured for allowing a retailer to retrieve pending orders from the gaming platform 3 and to confirm execution of pending orders to the gaming platform 3.

The retailer interface 10 comprises an electronic retailer device 26 installed at a retailer and connected to the gaming platform 3 through the data communication network 22.

The retailer device 26 comprises a processor, a memory, a display. The retailer device 26 comprises a network interface 27 for communication through the communication network 22.

The retailer interface 10 comprises a software retailer application 28. The retailer application 28 is a software application installed on the retailer device 26. Alternatively, the retailer application 28 is a software application hosted on a remote server, namely the booking server 4, the retailer device 26 enabling the retailer to access the retailer application through the communication network 22.

The retailer interface 10 comprises a retailer interface reader 30 adapted for communication with the player identification device 12 using short range wireless communication technology.

The retailer interface reader 30 is configured for reading the identification code stored in the player identification device 12 upon presentation of the player identification device 12 before the player device reader 22.

The retailer interface 10 is configured to confirm execution of a selected pending order in the game system 3. The retailer interface 10 is configured such that it can confirm the execution of a selected order requests presenting to the retailer interface reader 30 the player identification device 12 having the identification code matching the selected pending order. The retailer interface 10 is configured to trigger execution of a selected pending order upon presenting to the retailer interface reader 30 the player identification device 12 having the identification code matching that of the selected pending order.

The gaming platform 3 is configured to associate each executed order to transaction data.

Preferably, the retailer interface 10 is configured such that upon presentation of the player identification device 12, the retailer interface 10 retrieves from the gaming platform 3 and displays the pending orders matching the identification code of the player identification device 12.

The retailer interface 10 is configured to allow selecting at least one pending order associated to an identification code and confirming execution of the order upon presentation of the player identification device 12 matching the identification code to the retailer interface reader 30.

Optionally, the retailer interface 10 is configured for allowing to prepare orders. The retailer is thus allowed to prepare orders on behalf of a player, execution of the orders requirement the player to present his player identification device 12.

Advantageously, the player identification device 12 allows the player to claim his gains to the retailer by presenting the player identification device 12 to the retailer interface reader 30. To this end, the retailer interface 10 is configured for retrieving from the gaming platform 3 the gains associated to the identification code read in a player identification device 12 presented to the retailer interface reader 30. The retailer interface 10 is preferably configured for communicating to the gaming platform 3 that gains related to one or several orders of a player have been reclaimed and paid.

Alternatively or optionally, the retailer interface 10 comprises a printer 24 for printing a receipt for the player, the receipt carrying information relating to placed order (a unique serial number, predictions, stakes, . . . ). The player may thus use the paper receipt to reclaim gains. Advantageously, the receipt has a coding image printed thereon, the image coding information related to the placed order, and the retailer interface 10 comprises a scanner 26 for scanning the image to identifying the corresponding order.

Payment of high prizes may require specific process done at the back office level for instance according to the betting and/or lottery operator policy.

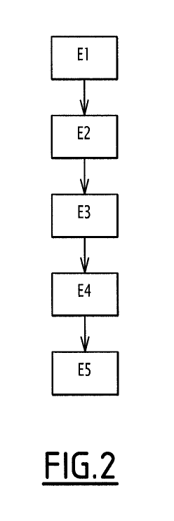

FIG. 2 illustrates steps of a process of booking and placing a bet and/or lottery wager order implemented using the game assembly of FIG. 1.

In a first step E1, the player presents his player identification device 12 to the player interface reader 24. The player interface 8 opens the account matching the identification code read in the player identification device 12.

In a second step E2, the player prepares a bet and/or lottery wager orders and presents his player identification device 12 to the player interface reader 24 to trigger booking of the order. The player interface 8 associate the identification code read in the player identification device 12 with the pending order in the booking server 4.

In a third step E3, the player presents his player identification device 12 to the retailer interface reader 30. The retailer interface 10 opens the account matching the identification code read in the player identification device 12.

In a fourth step E4, the retailer selects the order and the player triggers execution of the order by paying the order and optionally presenting his player identification device 12 to the retailer interface reader 30. The gaming platform 3 places the order and returns to the retailer interface 10 order and transaction data.

In a fifth step E5, the player presents his player identification device to the retailer interface reader 30. The retailer interface 10 opens the account matching the identification code read in the player identification device 12. The retailer checks the wins of the player and cashes out the wins. Alternatively the payment is done with the receipt carrying the information relating to placed order.

The distribution of the identification code is operated by distributing the player identification device 12 having the identification code and any additional security feature required already embedded in a physical support such as a card, token, sticker, etc. Alternatively or optionally, the support is distributed empty and initialized at first use with the player interface 8 or retailer interface 10 writing in it the identification code with any additional security feature required. Alternatively or optionally, the identification code and any additional security feature required are installed on a personal portable player device belonging to the player, such as a mobile device, in particular a smartphone.

Optionally, the identification code is digitally signed by the bet and/or lottery operator, using for instance asymmetric cryptology in order to prevent a player identification device to be issued by another party.

Optionally, the player identification device 12 and/or the gaming platform 3 stores a password such has a personal identification number (PIN) or a secret to be entered in by the player for authorizing specific operations, such a placing orders above a predetermined ordering amount or claiming gains above a predetermined claiming amount.

The player device, either owned by the player or located at a retailer, enables the player to access the offer in its full extent in a manner aimed to be more efficient than the methods of the existing art based on events paper lists or digital displays. Methods to make this are virtually unlimited and may include for instance event path browsing solution, easy natural search engine to get instant access to the Markets being searched, access to Markets in relation with favorite teams, access to player favorite lottery numbers, access to random generator to facilitate the choice of grids, etc.

The player interface enables the player to prepare his bet(s) and/or lottery wager(s) and to book them by presenting his player identification device close to player device reader. This enables to eliminate the need of paper lists, digital displays and paper coupons to fill the bets in or the lottery numbers in.

The invention enables interactions with the player through a player application that is installed on the player device or alternatively remotely accessed from the player device, such interactions enabling the player to get easy access to the current offer of the betting and/or lottery operator by connecting through a communication network to a source of data containing information related to the current offer, to prepare bets and/or lottery wagers and to associate such prepared bets and/or lottery wagers to its identification code using his player identification device, such operation resulting in booked bets and/or booked lottery wagers, pending for confirmation to be stored in the database of a booking server. The source of data containing information related to the current offer displayed on the player device can be delivered by the booking server, which can get such information from gaming server and/or any other source made available.

Variants to the embodiments describes above are possible.

The gaming platform of FIG. 1 comprises separated booking server and gaming server which communicate to confirm execution of order. Namely, the booking server manages orders and communicates the confirmation of orders to the gaming server for execution of the orders by the gaming server. Alternatively, the same booking and gaming server manages and execute orders.

What is claimed is:

1. A gaming system for placing bet and/or lottery wager orders, the gaming system comprising:
at least one portable player identification device, each player identification device storing a respective digital invariant unique identification code in a memory and comprising a short range wireless communication interface capable of reading the identification code in the memory;
at least one interface having a short range wireless communication reader for reading the identification code stored in a player identification presented to the reader, the interface being configured to confirm execution of a pending bet and/or lottery wager order to a gaming platform, each pending order being associated to an identification code, with requesting presentation of the player identification device matching the identification code associated to the pending order to allow confirmation of the pending order.

2. The gaming system as in claim 1 further comprising a player interface freely accessible to at least one player.

3. The gaming system as in claim 2 wherein the player interface is configured for preparation of bet and/or lottery wager orders.

4. The gaming system as in claim 2 wherein the player interface is configured to associate an identification code to a prepared order by reading the identification code stored in a portable player identification device via short range communication.

5. The gaming system as in claim 2 wherein the player interface is configured for confirming a pending order to the gaming platform with requesting presentation of the player identification device matching the identification code associated to the pending order to allow confirmation of the pending order.

6. The gaming system as in claim 1 further comprising a retailer interface accessible to a retailer.

7. The gaming system as in claim 6 wherein the retailer interface is configured to retrieve pending offers from the gaming platform.

8. The gaming system as in claim 6 wherein the retailer interface is configured for preparation of bet and/or lottery wager orders.

9. The gaming system as in claim 6 wherein a retailer interface is configured to associate an identification code to a prepared order by reading the identification code stored in a portable player identification device via short range communication.

10. The gaming system as in claim 6 wherein a retailer interface is configured for confirming a pending order to the gaming platform with requesting presentation of the player identification device matching the identification code associated to a pending order to allow confirmation of the pending order.

11. The gaming system as in claim 1 further comprising a gaming platform configured for recording pending bet and/or lottery wager orders prepared by players and for executing pending order upon confirmation, each pending order being associated to an identification code.

12. The gaming system as in claim 11 wherein each interface is in communication with the gaming platform over a data communication network.

13. A method of ordering bets and/lottery wagers, comprising: preparing and storing at least one pending bet and/or lottery wager order, each pending order being associated to an identification code, and confirming each pending order for execution of the order in a gaming platform only upon reading via short range communication an identification code stored in a portable player identification device storing a digital invariant unique identification code, the identification code read matching the identification code of the pending order.

14. The method of claim 13 further comprising associating an identification code to a prepared order by reading via short range communication the identification code stored in a portable player identification device.
